(19) United States
(12) Patent Application Publication
(10) Pub. No.: US 2023/0118754 A1
(43) Pub. Date: Apr. 20, 2023

(54) METHOD AND SYSTEM FOR DATA RETENTION IN PRUNED BLOCKCHAINS

(71) Applicant: MASTERCARD INTERNATIONAL INCORPORATED, Purchase, NY (US)

(72) Inventors: Robert Collins, Blackrock (IE); Conor McQuillan, Stillorgan (IE); Peter Nolan, Dun Laoghaire (IE)

(73) Assignee: MASTERCARD INTERNATIONAL INCORPORATED, Purchase, NY (US)

(21) Appl. No.: 17/451,329

(22) Filed: Oct. 19, 2021

(51) Int. Cl. G06Q 20/38; H04L 9/32

(52) U.S. Cl. CPC G06Q 20/3829; G06Q 20/3827; G06Q 20/38215; H04L 9/3242; H04L 2209/56; H04L 2209/38

(57) ABSTRACT

A method for verification of a pruned blockchain transaction includes: receiving, by a receiver of a computing device, a subset of blocks included in a plurality of blocks comprising a blockchain, wherein each block includes one or more blockchain data values; receiving, by the receiver of the computing device, an authentication code; identifying, by a processor of the computing device, a plurality of data chunks in the subset of blocks using the authentication code, where each data chunk of the plurality of data chunks is included in one of the one or more blockchain data values in a block of the subset of blocks; decoding, by the processor of the computing device, a transaction value using at least the identified plurality of data chunks and a fountain code algorithm; and verifying, by the processor of the computing device, the decoded transaction value.

### FIELD

The present disclosure relates to the verification of past transactions in a pruned blockchain, specifically the use of a fountain code algorithm to enable a pruned blockchain transaction to be decoded for verification without repeated posting of the transaction on the blockchain.

### BACKGROUND

Blockchain was initially created as a storage mechanism for use in conducting payment transactions with a cryptographic currency. Using a blockchain provides a number of benefits, such as decentralization, distributed computing, transparency regarding transactions, and yet also providing anonymity as to the individuals or entities involved in a transaction. One of the more popular aspects of a blockchain is that it is an immutable record: every transaction ever that is part of the chain is stored therein and cannot be changed due to the computational requirements and bandwidth limitations, particularly as a chain gets longer and a blockchain network adds more nodes.

However, as more and more transactions are conducted or other data stored on the blockchain, the file size for the blockchain greatly increases. In many cases, old blockchain transactions may have little to no value in being kept, as they may not be used in any future transaction verifications if the currency transferred in those transactions has already been used again. In some blockchain networks, some nodes may be permitted to prune their blockchain by removing such transaction data from their storage. In such instances, the blockchain itself is not modified, but rather the data for the pruned transactions is missing from the nodes, which can result in a significant data size reduction for the node. Some nodes will not prune their copy of the blockchain to ensure the full chain is kept and available if necessary.

Nevertheless, some entities may wish to verify a past blockchain transaction that has been pruned from nodes accessible by the entity. In such cases, the transaction value for the pruned transaction may be completely unavailable to the blockchain node, and thus to the entity hoping to verify the transaction. The only recourse for such an entity is to identify a full copy of the blockchain from a node that has the full blockchain available, and then identify the transaction for verification. In such an instance, the full blockchain must be made available to the entity, negating the benefits of pruning and requiring significant data storage for the entity and available bandwidth for transmission of the blockchain data.

Thus, there is a need for a system that can enable an entity to verify a past blockchain transaction that has been pruned from the blockchain without requiring the entity to obtain a full copy of the blockchain or communicate with a node that has not pruned the blockchain.

### SUMMARY

The present disclosure provides a description of systems and methods for the posting of verifiable data chunks for a transaction on a pruned blockchain and the verification of pruned blockchain transactions using the verifiable data chunks. For any transaction that is to be pruned from the blockchain, the transaction value for that transaction is decoded into a series of data chunks using a fountain code algorithm. Those data chunks are identifiable using an authentication code set for the transaction, and then regularly posted to the blockchain, where only some of the data chunks may be posted in any given block and where data chunks may be posted more than once. An entity wishing to verify the transaction can identify data chunks related to the transaction using the authentication code and, once enough data chunks have been identified, decode the transaction using the fountain code algorithm. The entity can then verify the transaction value. Using the fountain code algorithm and data chunks, a full copy of the blockchain node does not have to be identified or used. In addition, the blockchain can stay pruned, with only small data chunks being posted in place of the pruned transaction values, where the data chunks themselves can be pruned after time as well. Thus, transactions remain verifiable while nodes enjoy the benefits of reduced file sizes for blockchains.

A method for verification of a pruned blockchain transaction includes: receiving, by a receiver of a computing device, a subset of blocks included in a plurality of blocks comprising a blockchain, wherein each block includes one or more blockchain data values; receiving, by the receiver of the computing device, an authentication code; identifying, by a processor of the computing device, a plurality of data chunks in the subset of blocks using the authentication code, where each data chunk of the plurality of data chunks is included in one of the one or more blockchain data values in a block of the subset of blocks; decoding, by the processor of the computing device, a transaction value using at least the identified plurality of data chunks and a fountain code algorithm; and verifying, by the processor of the computing device, the decoded transaction value.

A method for posting verifiable data chunks for a transaction on a pruned blockchain includes: receiving, by a receiver of a computing device, a transaction value; encoding, by a processor of the computing device, the transaction value into a plurality of data chunks using a fountain code algorithm; identifying, by the processor of the computing device, an authentication code corresponding to the plurality of data chunks, wherein each data chunk of the plurality of data chunks includes a portion of the authentication code; generating, by the processor of the computing device, at least two new blocks for the pruned blockchain, wherein each of the at least two new blocks includes a block header and one or more blockchain data values, and wherein the plurality of data chunks and corresponding portions of the authentication code are stored across the one or more blockchain data values of each of the at least two new blocks; and transmitting, by a transmitter of the computing device, the generated at least two new blocks to a plurality of blockchain nodes in a blockchain network associated with the pruned blockchain.

A system for verification of a pruned blockchain transaction includes: a computing device including a receiver receiving a subset of blocks included in a plurality of blocks comprising a blockchain, wherein each block includes one or more blockchain data values, and an authentication code, and a processor identifying a plurality of data chunks in the subset of blocks using the authentication code, where each data chunk of the plurality of data chunks is included in one of the one or more blockchain data values in a block of the subset of blocks, decoding a transaction value using at least the identified plurality of data chunks and a fountain code algorithm, and verifying the decoded transaction value.

A system for posting verifiable data chunks for a transaction on a pruned blockchain includes: a computing device; a blockchain network associated with the pruned blockchain; and a plurality of blockchain nodes included in the blockchain network, wherein the computing device includes a receiver receiving a transaction value, a processor encoding the transaction value into a plurality of data chunks using a fountain code algorithm, identifying an authentication code corresponding to the plurality of data chunks, wherein each data chunk of the plurality of data chunks includes a portion of the authentication code, and generating at least two new blocks for the pruned blockchain, wherein each of the at least two new blocks includes a block header and one or more blockchain data values, and wherein the plurality of data chunks and corresponding portions of the authentication code are stored across the one or more blockchain data values of each of the at least two new blocks, and a transmitter transmitting the generated at least two new blocks to the plurality of blockchain.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for verification of pruned transactions in a blockchain in accordance with exemplary embodiments.

FIG. 2 is a block diagram illustrating a computing system of the system of FIG. 1 for posting verifiable data chunks for a pruned blockchain transaction and verification thereof in accordance with exemplary embodiments.

FIG. 3 is a flow diagram illustrating a process for verifying a pruned transaction in a blockchain in accordance with exemplary embodiments.

FIG. 4 is a flow chart illustrating an exemplary method for verification of a pruned blockchain transaction in accordance with exemplary embodiments.

FIG. 5 is a flow chart illustrating an exemplary method for posting verifiable data chunks for a transaction on a pruned blockchain in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

### System for Verification of Pruned Blockchain Transactions

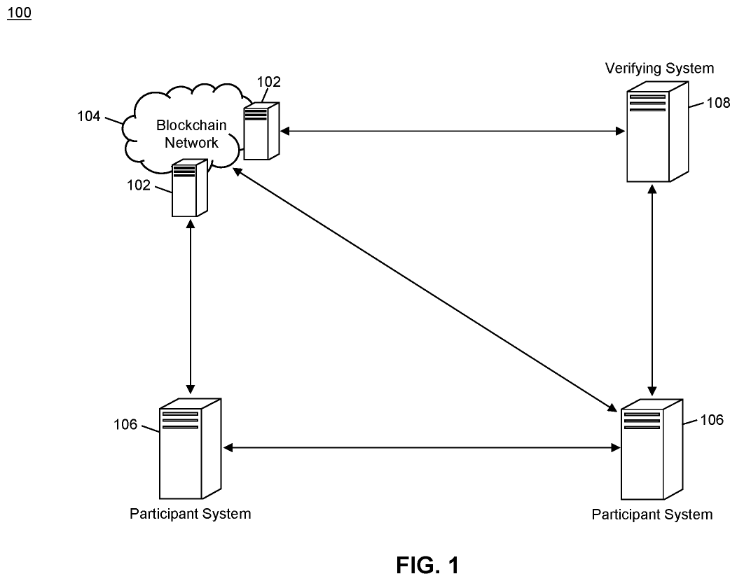

FIG. 1 illustrates a system 100 for the verification of transactions that have been pruned from a blockchain using a fountain code algorithm.

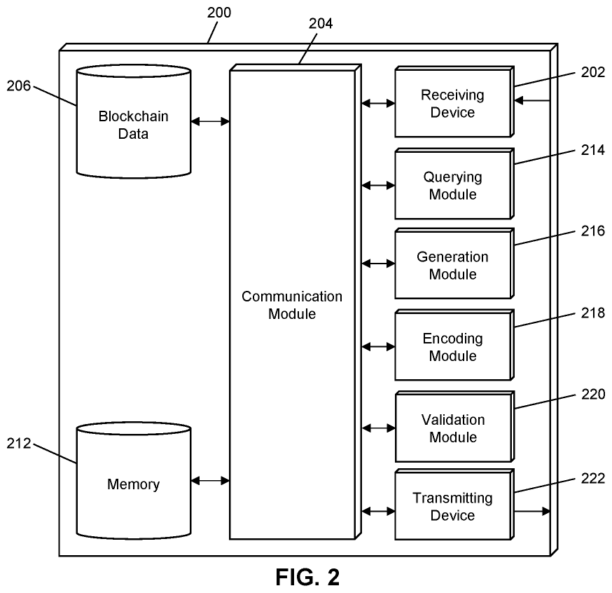

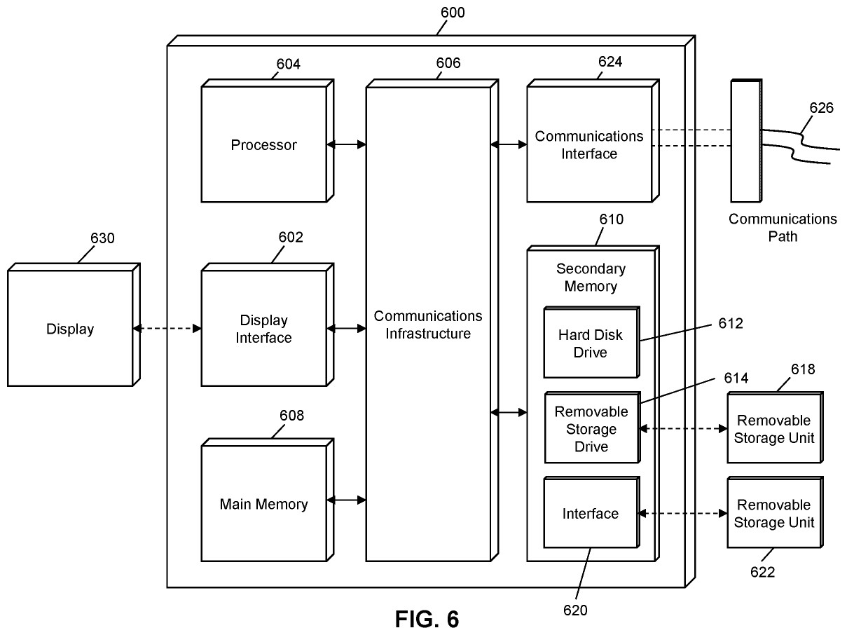

The system 100 may include one or more blockchain nodes 102. Each blockchain node 102 may be part of a blockchain network 104. Each blockchain node 102 may be a computing system, such as illustrated in FIGS. 2 and 6, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain may be a distributed ledger that is comprised of at least a plurality of blocks. Each block may include at least a block header and one or more data values. Each block header may include at least a timestamp, a block reference value, and a data reference value. The timestamp may be a time at which the block header was generated, and may be represented using any suitable method (e.g., UNIX timestamp, DateTime, etc.). The block reference value may be a value that references an earlier block (e.g., based on timestamp) in the blockchain. In some embodiments, a block reference value in a block header may be a reference to the block header of the most recently added block prior to the respective block. In an exemplary embodiment, the block reference value may be a hash value generated via the hashing of the block header of the most recently added block. The data reference value may similarly be a reference to the one or more data values stored in the block that includes the block header. In an exemplary embodiment, the data reference value may be a hash value generated via the hashing of the one or more data values. For instance, the block reference value may be the root of a Merkle tree generated using the one or more data values.

The use of the block reference value and data reference value in each block header may result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 102 in the blockchain network 104 prior to the generation and addition of a new block to the blockchain in order for the change to be made permanent. Computational and communication limitations may make such a modification exceedingly difficult, if not impossible, thus rendering the blockchain immutable.

In some embodiments, the blockchain may be used to store information regarding blockchain transactions conducted between two different blockchain wallets. A blockchain wallet may include a private key of a cryptographic key pair that is used to generate digital signatures that serve as authorization by a payer for a blockchain transaction, where the digital signature can be verified by the blockchain network 104 using the public key of the cryptographic key pair. In some cases, the term “blockchain wallet” may refer specifically to the private key. In other cases, the term “blockchain wallet” may refer to a computing device (e.g., participant systems 106) that stores the private key for use thereof in blockchain transactions. For instance, each computing device may each have their own private key for respective cryptographic key pairs, and may each be a blockchain wallet for use in transactions with the blockchain associated with the blockchain network. Computing devices may be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain may correspond to a blockchain transaction or other storage of data, as applicable, which may also be referred to herein as a “transaction value.” A blockchain transaction may consist of at least: a digital signature of the sender of currency (e.g., a participant system 106) that is generated using the sender's private key, a blockchain address of the recipient of currency (e.g., another participant system 106) generated using the recipient's public key, and a blockchain currency amount that is transferred or other data being stored. In the case of the blockchain being used for data storage separate from currency, the currency amount may be replaced by such other data. In some blockchain transactions, the transaction may also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction may also include the sender's public key, for use by an entity in validating the transaction. For the traditional processing of a blockchain transaction, such data may be provided to a blockchain node 102 in the blockchain network 104, either by the sender or the recipient. The node may verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block may be validated by other nodes in the blockchain network 104 before being added to the blockchain and distributed to all of the blockchain nodes 102 in the blockchain network 104 in traditional blockchain implementations. In cases where a blockchain data value may not be related to a blockchain transaction, but instead the storage of other types of data, blockchain data values may still include or otherwise involve the validation of a digital signature.

In some embodiments, the blockchain network 104 may operate and store a provenance blockchain. A provenance blockchain may be a blockchain that stores data regarding a supply chain, where events in the supply chain are stored therein. Such events may include, for instance, product manufacture, pickup by a distribution entity, transportation from one storage facility to another, delivery to a retailer, sale by the retailer, resale by a consumer, addition of a product to a grouping of products, separation of a product from a grouping of products, chargeback of a product, etc. In some cases, a blockchain data value stored in the provenance blockchain for such an event may include detailed information about the event. In other cases, the blockchain data value may include a hash value of detailed information about the event, where the detailed information may be stored in a separate data storage. In some instances, documents and other data may be stored in the blockchain data values, such as directly or via hash values that can be used to verify the underlying data (e.g., an executed contract) that may be stored elsewhere, such as possessed by the entities involved in the executed contract. Additional information regarding the use and operation of provenance blockchains can be found in U.S. patent application Ser. No. 16/875,154, entitled “Method and System for Generalized Provenance Solution for Blockchain Supply Chain Applications,” by Steven C. Davis et al., filed May 15, 2020, which is herein incorporated by reference in its entirety.

In the system 100, one or more blockchain nodes 102 may prune their local copy of the blockchain. Pruning of the blockchain may include the deletion of one or more transaction values from local data storage in an effort to reduce the overall data size of blockchain data stored by the blockchain node 102. Pruning of transaction values may not affect the blockchain itself in any way, such as by requiring modification to any block headers or hash values. In some cases, transaction values may be pruned after a predetermined period of time, such as when a block has reached a certain age (e.g., three months old, six months old, one year old, etc.). In other cases, transaction values may be pruned after they have not been accessed for a predetermined period of time. For instance, if a transaction value is regularly accessed by the blockchain node 102 or requested by an external system, the transaction value may not be pruned.

However, there may be an instance where a third party, such as a verifying system 108, may have an interest in verifying a blockchain transaction once the transaction value has already been pruned from the blockchain by a blockchain node 102. For example, if the blockchain is a provenance blockchain, the verifying system 108 may be a consumer that is purchasing a luxury item secondhand and wanting to verify the authenticity of the product, which may have been initially purchased a significant time prior, resulting in transaction values regarding the luxury item having been pruned from the blockchain by the blockchain node 102. In such an example, the verifying system 108 may need to verify pruned transaction values.

In order to enable the verification of pruned transaction values, a fountain code algorithm may be used by blockchain nodes 102. When a transaction value is to be pruned from the blockchain, the blockchain node 102, or a separate blockchain node 102 that may be configured to perform encoding processes on behalf of other blockchain nodes 102, may encode the transaction value into a plurality of verifiable data chunks using a fountain code algorithm, such as Raptor code or RaptorQ, which are fountain codes that encode a given source block of data consisting of a number k of equal size symbols into a sequence of encoding symbols. The reception of any k or more encoding symbols allows the source block to be recovered with some non-zero probability. See. e.g., Amin Shokrollahi and Michael Luby (2011). “Raptor Codes”. Foundations and Trends in Communications and Information Theory. Now Publishers. 6 (3-4): 213-322. doi:10.1561/0100000060. The blockchain node 102 may generate a large number of the verifiable data chunks, also referred to as blocks. These data chunks may then be posted to the blockchain, where a blockchain data value may include one or more verifiable data chunks for the pruned transaction value. In some cases, new blockchain data values may be posted periodically, such as every hour, every day, or every week. In some instances, the number of verifiable data chunks posted in a blockchain data value may be predetermined and/or may be consistent across new blockchain data values for a specific transaction value.

The verifying system 108 may identify verifiable data chunks for the transaction value it wishes to verify. Once enough verifiable data chunks have been identified by the verifying system 108 in the blockchain, the verifying system 108 may decode the transaction value using the fountain code algorithm. In an exemplary embodiment, the verifying system 108 may be required to identify a number of verifiable data chunks that is slightly larger than a set of source symbols that makes up the original transaction value. The decoding of the verifiable data chunks to obtain the transaction value may depend on the type of fountain code algorithm used. For example, if RaptorQ is used, XOR operations may be used on data chunks for both encoding and decoding. Once the verifying system 108 has obtained the original transaction value, the verifying system 108 may then verify the transaction value itself. For instance, in the above example, the consumer may verify the authenticity of the luxury item they are purchasing such as by ensuring the chain of custody to the seller.

In some embodiments, data chunks for a pruned blockchain transaction may only be posted upon request, such as from a verifying system 108. For instance, the verifying system 108 may request a transaction value for verifying, which the blockchain node 102 may identify has been pruned from its blockchain data. The blockchain node 102 may then proceed to post verifiable data chunks for the pruned transaction to the blockchain across a plurality of new blocks. By posting data chunks instead of the full transaction value, errors in processing of the blockchain may be avoided, such as may result if the transaction value was posted again (e.g., where the transaction value may appear to be spending blockchain currency that has already been transferred to other blockchain wallets), while still enabling the verifying system 108 to verify the transaction value once a sufficient number of data chunks have been identified. In addition, the data chunks may be pruned by the blockchain node 102 as well after a time, such as after a predetermined period, and/or once the verifying system 108 indicates that the transaction value has been successfully decoded thereby.

In some embodiments, authentication codes may be used to assist in the identification of data chunks for a specific transaction value. In such embodiments, an authentication code may be identified for pruned blockchain transactions. In some cases, an authentication code may be identified for every blockchain transaction. In some cases, an authentication code identified for a transaction value may be stored in the blockchain data value for that blockchain transaction. In some instance, when a transaction value is pruned from blockchain data, the authentication code may be retained in the blockchain data. The authentication code may be any value that may be unique to a transaction value and used for identification thereof, such as an integer or alphanumeric value of sufficient size. In cases where the blockchain is a provenance blockchain, unique product identifiers, such as a serial number, may be used as authentication codes. In such embodiments, the verifying system 108 may use an authentication code when requesting a transaction value or data chunks. In some cases, the blockchain data entries that are posted to the blockchain with data chunks encoded from a transaction value may be accompanied by the authentication code for that transaction value, such as to enable easier identification of the data chunks by the verifying system 108. In some instances, the verifying system 108 may identify the authentication code for a transaction value it wants to verify in the blockchain itself, or may receive the authentication code from an external system, such as a participant system 106. For instance, in the above example, the seller of the luxury item may provide the authentication code (e.g., a serial number of the luxury item) to the verifying system 108, which may then request the transaction value or identify data chunks for the transaction value using that authentication code.

In some embodiments, the system 100 may also use chaffing and winnowing when verifiable data chunks are posted to the blockchain for decoding into the underlying transaction value. For example, a blockchain node 102 may add chaff data chunks into a blockchain data entry along with the verifiable data chunks obtained from encoding the transaction value, where each data chunk includes a code portion. The code portion included with the verifiable data chunks may be a portion of the authentication code for the transaction value, while the chaff data chunks may include code portions that are randomly generated or otherwise do not correspond to the authentication code. In such embodiments, the verifying system 108 may be able to identify the genuine data chunks in the blockchain data entries using the authentication code and thereby ignore the chaff data packets. The verifying system 108 can then decode the transaction value using the genuine data chunks obtained from a plurality of different blockchain data values.

In some instances, the authentication code used for identification of a transaction value may be separate from an authentication code used for identifying genuine data chunks using the chaffing and winnowing process. For example, an identification number may be identified for a transaction for use as the authentication code used to identify blockchain data entries that correspond to a specific transaction value, while the product's serial number may be used to identify the genuine data chunks in the identified blockchain data entries.

The methods and systems discussed herein enable blockchain nodes 102 in a blockchain network 104 to prune old transaction values from local data storage while still retaining the ability to provide enough data to a requesting system, such as a verifying system 108, to recover a pruned transaction value for verification thereof. The use of fountain code algorithms ensure that a transaction value can be recovered without posting the actual transaction value again and without increasing data sizes, where the data chunks themselves can also be pruned to ensure that the local data storage for the blockchain node 102 is always less than cases where the blockchain is not pruned. Thus, the methods and systems discussed herein can provide for full verification of blockchain transactions while still enabling a blockchain to be pruned to reduce overall data storage.

### Computing System

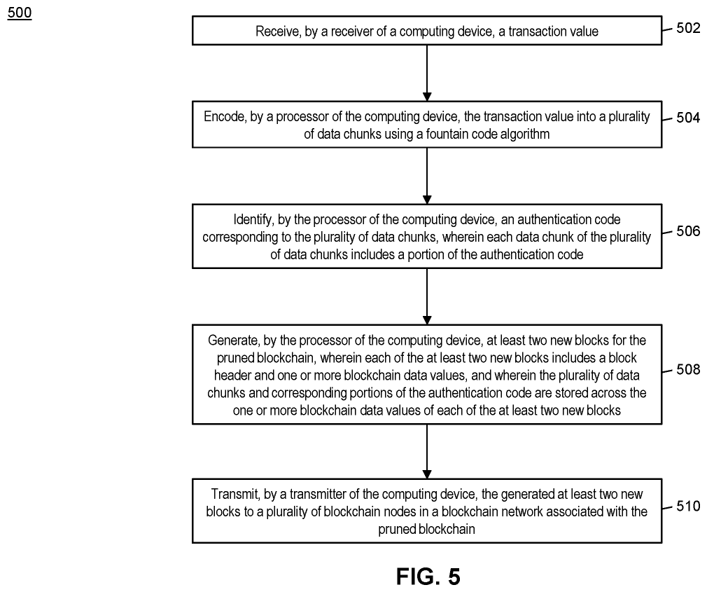

FIG. 2 illustrates an embodiment of a computing system 200 in the system 100. It will be apparent to persons having skill in the relevant art that the embodiment of the computing system 200 illustrated in FIG. 2 is provided as illustration only and may not be exhaustive to all possible configurations of the computing system 200 suitable for performing the functions as discussed herein. For example, the computer system 600 illustrated in FIG. 5 and discussed in more detail below may be a suitable configuration of the computing system 200. Blockchain nodes 102, the participant system 106 and the verifying system 108 in the system 100 of FIG. 1 may be implemented as the computing system 200 (e.g., or computer system 600) and include one or more of the components as illustrated in FIG. 2 or discussed below.

The computing system 200 may include a receiving device 202. The receiving device 202 may be configured to receive data over one or more networks via one or more network protocols. In some instances, the receiving device 202 may be configured to receive data from blockchain nodes 102, participant systems 106, verifying systems 108, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by blockchain nodes 102, which may be superimposed or otherwise encoded with blockchain data values, transaction values, blocks, authentication codes, verifiable data chunks, confirmation messages, etc. The receiving device 202 may also be configured to receive data signals electronically transmitted by participant systems 106 or verifying systems 108, such as may be superimposed or otherwise encoded with new transaction values, requests for transaction values, requests for verifiable data chunks, authentication codes, notifications of decoded transaction values, etc.

The computing system 200 may also include a communication module 204. The communication module 204 may be configured to transmit data between modules, engines, databases, memories, and other components of the computing system 200 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the computing system 200 and external components of the computing system 200, such as externally connected databases, display devices, input devices, etc. The computing system 200 may also include a processing device. The processing device may be configured to perform the functions of the computing system 200 discussed herein as will be apparent to persons having skill in the relevant art. In some embodiments, the processing device may include and/or be comprised of a plurality of engines and/or modules specially configured to perform one or more functions of the processing device, such as a querying module 214, generation module 216, encoding module 218, validation module 220, etc. As used herein, the term “module” may be software executed on hardware or hardware particularly programmed to receive an input, perform one or more processes using the input, and provides an output. The input, output, and processes performed by various modules will be apparent to one skilled in the art based upon the present disclosure.

The computing system 200 may also include blockchain data 206, which may be stored in a memory 212 of the computing system 200 or stored in a separate area within the computing system 200 or accessible thereby. The blockchain data 206 may include a blockchain, which may be comprised of a plurality of blocks and be associated with the blockchain network 104. The blockchain data 206 may also or alternatively include any data associated with one or more blockchain wallets that may be used by the computing system 200, such as cryptographic key pairs, unspent transaction outputs, digital asset amounts, network identifiers for the blockchain network 104, smart contracts, signature generation algorithms, encryption algorithms, transaction account data, account balances, communication information for third party services, etc. The blockchain data 206 may also include verifiable data chunks, authentication codes, and other data as discussed herein used in the verification of pruned transaction values. In some cases, blockchain data values and/or transaction values may be pruned from the blockchain data 206 at predetermined intervals or based on predefined criteria, such as a predetermined period of time since a block was added or a transaction value accessed.

The computing system 200 may also include a memory 212. The memory 212 may be configured to store data for use by the computing system 200 in performing the functions discussed herein, such as public and private keys, symmetric keys, etc. The memory 212 may be configured to store data using suitable data formatting methods and schema and may be any suitable type of memory, such as read-only memory, random access memory, etc. The memory 212 may include, for example, encryption keys and algorithms, communication protocols and standards, data formatting standards and protocols, program code for modules and application programs of the processing device, and other data that may be suitable for use by the computing system 200 in the performance of the functions disclosed herein as will be apparent to persons having skill in the relevant art. In some embodiments, the memory 212 may be comprised of or may otherwise include a relational database that utilizes structured query language for the storage, identification, modifying, updating, accessing, etc. of structured data sets stored therein. The memory 212 may be configured to store, for example, cryptographic keys, salts, nonces, communication information for blockchain nodes 102 and blockchain networks 104, address generation and validation algorithms, digital signature generation and validation algorithms, hashing algorithms for generating reference values, data for the generation and execution of smart contracts, configuration data, trigger data, formatting standards, transaction processing rules, fountain code algorithms, chaff packet generation rules, etc.

The computing system 200 may include a querying module 214. The querying module 214 may be configured to execute queries on databases to identify information. The querying module 214 may receive one or more data values or query strings, and may execute a query string based thereon on an indicated database, such as the memory 212 of the computing system 200 to identify information stored therein. The querying module 214 may then output the identified information to an appropriate engine or module of the computing system 200 as necessary. The querying module 214 may, for example, execute a query on the blockchain data 206 to identify a transaction value for use in encoding to obtain verifiable data chunks.

The computing system 200 may also include a generation module 216. The generation module 216 may be configured to generate data for use by the computing system 200 in performing the functions discussed herein. The generation module 216 may receive instructions as input, may generate data based on the instructions, and may output the generated data to one or more modules of the computing system 200. For example, the generation module 216 may be configured to generate blockchain data values, new blocks, block headers, reference values, smart contracts, transaction messages, trigger events, etc. The generation module 216 or other processing module of the computing system 200 may be further configured to perform actions, such as via the execution of smart contracts or other actions that may be necessary to maintain trigger events or initiate electronic payment transactions.

The computing system 200 may also include an encoding module 218. The encoding module 218 may be configured to perform encoding or decoding operations as part of the methods and systems discussed herein. The encoding module 218 may receive data for encoding and decoding and instructions for execution by the encoding module 218 on the received data. The encoding module 218 may perform encoding or decoding operations as instructed and output the resulting data to another module or engine of the computing system 200. The encoding module 218 may be configured to, for example, encode a transaction value to obtain verifiable data chunks using a fountain code algorithm. The encoding module 218 may also be configured to decode identified verifiable data chunks using a fountain code algorithm to identify a transaction value.

The computing system 200 may also include a validation module 220. The validation module 220 may be configured to perform validations for the computing system 200 as part of the functions discussed herein. The validation module 220 may receive instructions as input, which may also include data to be used in performing a validation, may perform a validation as requested, and may output a result of the validation to another module or engine of the computing system 200. The validation module 220 may, for example, be configured to validate digital signatures using suitable signature generation algorithms and keys, validate transaction values, validate block reference hashes, validate data reference hashes, etc.

The computing system 200 may also include a transmitting device 222. The transmitting device 222 may be configured to transmit data over one or more networks via one or more network protocols. In some instances, the transmitting device 222 may be configured to transmit data to blockchain nodes 102, participant systems 106, verifying systems 108, and other entities via one or more communication methods, local area networks, wireless area networks, cellular communication, Bluetooth, radio frequency, the Internet, etc. In some embodiments, the transmitting device 222 may be comprised of multiple devices, such as different transmitting devices for transmitting data over different networks, such as a first transmitting device for transmitting data over a local area network and a second transmitting device for transmitting data via the Internet. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals to blockchain nodes 102, which may be superimposed or otherwise encoded with blockchain data values, transaction values, blocks, authentication codes, verifiable data chunks, confirmation messages, new transaction values, requests for transaction values, requests for verifiable data chunks, authentication codes, notifications of decoded transaction values, etc. The transmitting device 222 may also be configured to electronically transmit data signals to verifying systems 108, which may be superimposed or otherwise encoded with blockchain data values, verifiable data chunks, authentication codes, etc.

### Process for Verifying Pruned Transaction Values

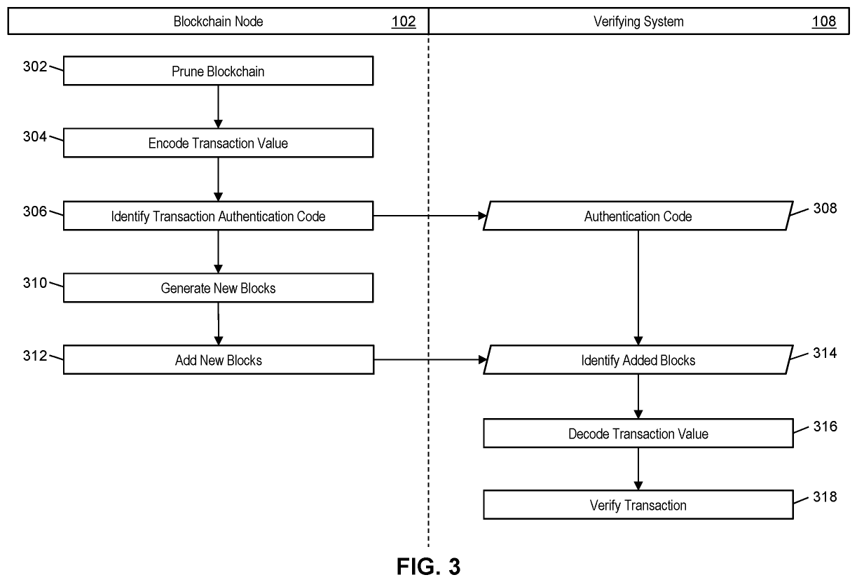

FIG. 3 illustrates a process for verifying a transaction value that has been pruned from a blockchain through the use of verifiable data chunks in the system 100 illustrated in FIG. 1 and discussed above.

In step 302, the blockchain node 102 may prune its local copy of the blockchain (e.g., stored in blockchain data 206) by removing one or more transaction values from the data store. The blockchain node 102 may be instructed to post data chunks for a pruned blockchain transaction, such as based on a predetermined period of time since the transaction value was pruned in step 302 or upon receipt of a request for the transaction value (e.g., identified via an authentication code) from an external system, such as the verifying system 108. In step 304, the blockchain node 102 may (e.g., via an encoding module 218) encode the transaction value using a fountain code algorithm to identify a plurality of verifiable data chunks for the transaction value.

In step 306, the blockchain node 102 may (e.g., via a querying module 214 or generation module 216) identify an authentication code to be used in identification of the identifiable data chunks for decoding of the transaction value. The authentication code may be broken down into code portions, where each data chunk may be accompanied by a code portion. In step 308, the verifying system 108 may receive the authentication code, such as from the blockchain node 102 directly (e.g., as response to a request for the transaction value) or identification thereof in a blockchain data value.

In step 310, the blockchain node 102 may (e.g., via a generation module 216) generate new blocks for the blockchain using traditional methods and systems, where new blocks may include one or more blockchain data values and where identifiable data chunks and corresponding code portions may be stored across the blockchain data values. In step 312, the new blocks may be added to the blockchain using traditional methods and systems, such as where the new blocks are transmitted to a plurality of other blockchain nodes 102, confirmed thereby, and distributed to the blockchain nodes 102 in the blockchain network 104.

To verify the transaction value, in step 314, the verifying system 108 may identify the new blocks that have been added to the blockchain since pruning of the transaction value, or since submission of a request for the transaction value to the blockchain node 102, as applicable. The verifying system 108 may also identify the verifiable data chunks for the transaction value in the blockchain data entries of the new blocks using the authentication code, such as by identifying verifiable data chunks that are accompanied by code portions that comprise the authentication code. In step 316, the verifying system 108 may (e.g., via an encoding module 218) decode the transaction value using the identified data chunks and a fountain code algorithm. In step 318, the verifying system 108 may then (e.g., via a validation module 220) verify the transaction value, such as by ensuring authenticity of a product in a provenance blockchain or validating a transaction amount transferred from a first blockchain wallet to a second blockchain wallet.

### Exemplary Method for Verification of a Pruned Blockchain Transaction

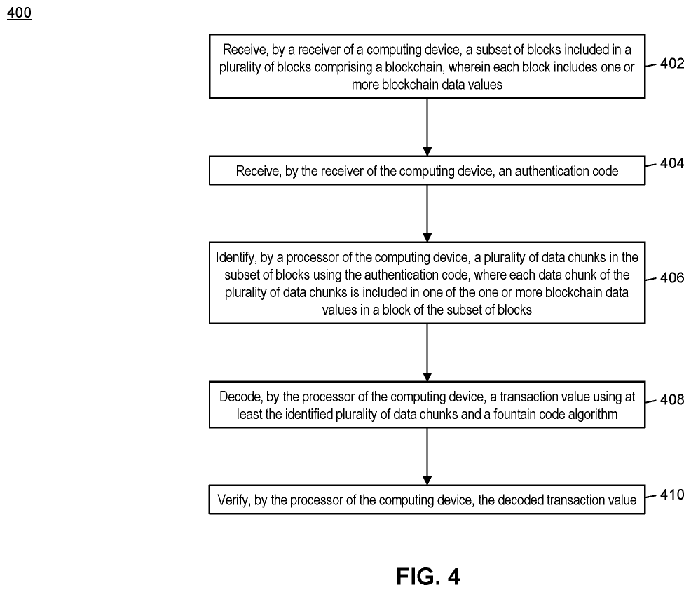

FIG. 4 illustrates a method 400 for the verification of a blockchain transaction pruned from a blockchain through the use of a fountain code algorithm and verifiable data chunks.

In step 402, a subset of blocks included in a plurality of blocks comprising a blockchain may be received by a receiver (e.g., receiving device 202) of a computing device (e.g., computing system 200, verifying system 108, etc.), wherein each block includes one or more blockchain data values. In step 404, an authentication code may be received by the receiver of the computing device. In step 406, a plurality of data chunks may be identified in the subset of blocks by a processor (e.g., querying module 214) of the computing device using the authentication code, where each data chunk of the plurality of data chunks is included in one of the one or more blockchain data values in a block of the subset of blocks.

In step 408, a transaction value may be decoded by the processor (e.g., encoding module 218) of the computing device using at least the identified plurality of data chunks and a fountain code algorithm. In step 410, the decoded transaction value may be verified by the processor (e.g., validation module 220) of the computing device.

In one embodiment, the method 400 may further include displaying, by a display device interfaced with the computing device, a result of verifying the decoded transaction value. In some embodiments, the authentication code may be stored in one of the one or more blockchain data values in a block of the plurality of blocks. In some embodiments, verifying the decoded transaction value may include validating a digital signature included in the decoded transaction value using a public key of a cryptographic key pair. In one embodiment, the authentication code may be a product identifier associated with a product, and the decoded transaction value may include data indicating transfer of possession of the product. In some embodiments, the blockchain may be a pruned blockchain.

### Exemplary Method for Posting Verifiable Data Chunks

FIG. 5 illustrates a method 500 for posting verifiable data chunks for a transaction on a pruned blockchain that can be used to decode an underlying transaction value using a fountain code algorithm.

In step 502, a transaction value may be received by a receiver (e.g., receiving device 202) of a computing device (e.g., computing system 200, blockchain node 102, etc.). In step 504, the transaction value may be encoded by a processor (e.g., encoding module 218) of the computing device into a plurality of data chunks using a fountain code algorithm. In step 506, an authentication code corresponding to the plurality of data chunks may be identified by the processor (e.g., querying module 214, generation module 216, etc.) of the computing device, wherein each data chunk of the plurality of data chunks includes a portion of the authentication code.

In step 508, at least two new blocks for the pruned blockchain may be generated by the processor (e.g., generation module 216) of the computing device, wherein each of the at least two new blocks includes a block header and one or more blockchain data values, and wherein the plurality of data chunks and corresponding portions of the authentication code are stored across the one or more blockchain data values of each of the at least two new blocks. In step 510, the generated at least two new blocks may be transmitted by a transmitter (e.g., transmitting device 222) of the computing device to a plurality of blockchain nodes (e.g., blockchain nodes 102) in a blockchain network (e.g., blockchain network 104) associated with the pruned blockchain. In one embodiment, the two new blocks may not be consecutive in the pruned blockchain.

### Computer System Architecture

FIG. 6 illustrates a computer system 600 in which embodiments of the present disclosure, or portions thereof, may be implemented as computer-readable code. For example, the blockchain node 102 and verifying system 108 of FIG. 1 and the computing system 200 of FIG. 2 may be implemented in the computer system 600 using hardware, non-transitory computer readable media having instructions stored thereon, or a combination thereof and may be implemented in one or more computer systems or other processing systems. Hardware may embody modules and components used to implement the methods of FIGS. 3-5.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for verification of a pruned blockchain transaction and posting of verifiable data chunks for a transaction on a pruned blockchain. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for verification of a pruned blockchain transaction, comprising:
receiving, by a receiver of a computing device, a subset of blocks included in a plurality of blocks comprising a blockchain, wherein each block includes one or more blockchain data values;
receiving, by the receiver of the computing device, an authentication code;
identifying, by a processor of the computing device, a plurality of data chunks in the subset of blocks using the authentication code, where each data chunk of the plurality of data chunks is included in one of the one or more blockchain data values in a block of the subset of blocks;
decoding, by the processor of the computing device, a transaction value using at least the identified plurality of data chunks and a fountain code algorithm; and
verifying, by the processor of the computing device, the decoded transaction value.

2. The method of claim 1, further comprising:
displaying, by a display device interfaced with the computing device, a result of verifying the decoded transaction value.

3. The method of claim 1, wherein the authentication code is stored in one of the one or more blockchain data values in a block of the plurality of blocks.

4. The method of claim 1, wherein verifying the decoded transaction value includes validating a digital signature included in the decoded transaction value using a public key of a cryptographic key pair.

5. The method of claim 1, wherein
the authentication code is a product identifier associated with a product, and
the decoded transaction value includes data indicating transfer of possession of the product.

6. The method of claim 1, wherein the blockchain is a pruned blockchain.

7. A method for posting verifiable data chunks for a transaction on a pruned blockchain, comprising:
receiving, by a receiver of a computing device, a transaction value;
encoding, by a processor of the computing device, the transaction value into a plurality of data chunks using a fountain code algorithm;
identifying, by the processor of the computing device, an authentication code corresponding to the plurality of data chunks, wherein each data chunk of the plurality of data chunks includes a portion of the authentication code;
generating, by the processor of the computing device, at least two new blocks for the pruned blockchain, wherein each of the at least two new blocks includes a block header and one or more blockchain data values, and wherein the plurality of data chunks and corresponding portions of the authentication code are stored across the one or more blockchain data values of each of the at least two new blocks; and
transmitting, by a transmitter of the computing device, the generated at least two new blocks to a plurality of blockchain nodes in a blockchain network associated with the pruned blockchain.

8. The method of claim 7, wherein the two new blocks are not consecutive blocks in the pruned blockchain.

9. A system for verification of a pruned blockchain transaction, comprising:
a computing device including
a receiver receiving
a subset of blocks included in a plurality of blocks comprising a blockchain, wherein each block includes one or more blockchain data values, and
an authentication code, and
a processor
identifying a plurality of data chunks in the subset of blocks using the authentication code, where each data chunk of the plurality of data chunks is included in one of the one or more blockchain data values in a block of the subset of blocks,
decoding a transaction value using at least the identified plurality of data chunks and a fountain code algorithm, and
verifying the decoded transaction value.

10. The system of claim 9, further comprising:
a display device interfaced with the computing device displaying a result of verifying the decoded transaction value.

11. The system of claim 9, wherein the authentication code is stored in one of the one or more blockchain data values in a block of the plurality of blocks.

12. The system of claim 9, wherein verifying the decoded transaction value includes validating a digital signature included in the decoded transaction value using a public key of a cryptographic key pair.

13. The system of claim 9, wherein
the authentication code is a product identifier associated with a product, and
the decoded transaction value includes data indicating transfer of possession of the product.

14. The system of claim 9, wherein the blockchain is a pruned blockchain.

15. A system for posting verifiable data chunks for a transaction on a pruned blockchain, comprising:
a computing device;
a blockchain network associated with the pruned blockchain; and
a plurality of blockchain nodes included in the blockchain network, wherein
the computing device includes
a receiver receiving a transaction value,
a processor
encoding the transaction value into a plurality of data chunks using a fountain code algorithm,
identifying an authentication code corresponding to the plurality of data chunks, wherein each data chunk of the plurality of data chunks includes a portion of the authentication code, and
generating at least two new blocks for the pruned blockchain, wherein each of the at least two new blocks includes a block header and one or more blockchain data values, and wherein the plurality of data chunks and corresponding portions of the authentication code are stored across the one or more blockchain data values of each of the at least two new blocks, and
a transmitter transmitting the generated at least two new blocks to the plurality of blockchain.

16. The system of claim 15, wherein the two new blocks are not consecutive blocks in the pruned blockchain.
